(19) United States
(12) Patent Application Publication
(10) Pub. No.: US 2025/0271666 A1
(43) Pub. Date: Aug. 28, 2025

(54) COMPOSITE PANE FOR A PROJECTION ASSEMBLY

(71) Applicant: SAINT-GOBAIN GLASS FRANCE, COURBEVOIE (FR)

(72) Inventors: Andreas GOMER, HERZOGENRATH (DE); Martin NIEVELSTEIN, HERZOGENRATH (DE); Heinrich KLIEM, HERZOGENRATH (DE)

(21) Appl. No.: 18/856,496

(22) PCT Filed: Apr. 4, 2023
(86) PCT No.: PCT/EP2023/058734

§ 371 Date: Oct. 11, 2024

(30) Foreign Application Priority Data
Apr. 13, 2022 (EP) 22168064.8

(51) Int. Cl. G02B 27/01; B32B 17/10

(52) U.S. Cl. CPC G02B 27/0101; B32B 17/10036; B32B 17/10348; B32B 17/10513; B32B 17/10899; B32B 2605/00

(57) ABSTRACT

A laminated pane includes an inner and an outer pane, a thermoplastic intermediate layer, and functional layer element. The outer pane has an outer side facing away from the thermoplastic intermediate layer and an inner side facing the thermoplastic intermediate layer, and the inner pane has an outer side facing the thermoplastic intermediate layer and an inner side facing away from the thermoplastic intermediate layer. The functional layer element is arranged on the inner side of the inner pane and is suitable for emitting light. The functional layer element is a reflective layer or an active imaging element, and is itself opaque or is arranged spatially in front of an opaque background when viewed through the laminated pane starting from the inner side of the inner pane, and wherein a hydrophobic film is arranged at least on the functional layer element.

The invention relates to a laminated pane, in particular for a projection arrangement, and to its manufacture and use.

Head-up displays (HUD's) are nowadays frequently used in vehicles and aircraft. An HUD in this case functions by using an imaging unit, which, by means of an optics module and a projection surface, projects an image perceived by the driver as a virtual image. If this image is reflected, for example, via the vehicle windshield used as a projection surface, important information can be presented to the user which significantly improves traffic safety.

The problem with the above-described head-up displays is that the projector image is reflected on both surfaces of the windshield. As a result, the driver perceives not only the desired primary image that is produced by the reflection on the interior surface of the windshield (primary reflection). The driver also perceives a slightly offset secondary image that is generally less intense and is produced by the reflection on the outer surface of the windshield (secondary reflection). The latter is commonly also referred to as a ghost image. This problem is commonly solved by arranging the reflective surfaces at a specifically selected angle to one another so that the primary image and the ghost image are superimposed, as a result of which the ghost image no longer has a disruptive effect.

Typically, the radiation of the head-up display projector is substantially s-polarized due to the better reflection characteristics of the windshield compared to p-polarization. However, if the driver wears polarization-selective sunglasses which transmit only p-polarized light, he can hardly perceive the HUD image or cannot perceive it at all. There is therefore a need for HUD projection arrangements which are compatible with polarization-selective sunglasses. A solution to the problem in this context is therefore the use of projection arrangements which use p-polarized light.

DE102014220189A1 discloses a head-up display projection arrangement which is operated with p-polarized radiation in order to generate a head-up display image. Since the incidence angle is typically close to the Brewster angle, and p-polarized radiation is therefore reflected only to a small degree by the glass surfaces, the windshield has a reflective structure which can reflect p-polarized radiation towards the driver. Proposed as a reflective structure is a single metallic layer having a thickness of 5 nm to 9 nm, e.g., made of silver or aluminum, which is applied to the outer side, facing away from the interior of the passenger vehicle, of the inner pane.

WO2021/145387 A1 also describes a head-up display system for a windshield which is operated with p-polarized radiation. The system has a light source with p-polarized radiation and a reflective element which can reflect p-polarized radiation in the direction of the driver, wherein the angle of incidence of the p-polarized light on the inner side of the inner pane is selected to be between 42 and 72° in order to produce the brightest possible main image in contrast to the secondary images (ghost images) that occur. The reflective element can be a film or a coating that is arranged in the transparent region of the windshield.

WO2021/209201 A1 describes a projection arrangement for a head-up display of a laminated pane with p-polarized radiation in which an optically highly refractive coating is applied to the interior surface in order to achieve a higher contrast between the desired (main image) and undesired reflection (secondary/ghost images); although this coating increases the overall reflectivity of the interior surface, the ghost image appears less with p-polarized radiation compared to the desired main image. The HUD reflective layer is protected from environmental influences inside the laminated pane between the outer pane and the inner pane.

When designing a display which is based upon the head-up display technology, it must also be ensured that the projector has a correspondingly strong power so that the projected image has sufficient brightness and can be easily seen by the viewer, in particular when sunlight is incident. This requires a certain size of the projector and is associated with a corresponding power consumption.

In DE102009020824A1, a windshield with a virtual image system is disclosed. In this case, the image display device (projector) is directed to a reflective region which is either itself formed by a non-light-transmissive, reflective layer or is arranged in front of a non-light-transmissive background. The reflective layer is arranged on a surface of the inner pane facing the vehicle interior. As a result, the reflected image can be seen in high contrast. However, the reflective layer is not protected from external harmful influences.

US 2009/0295681 describes an image display system in which the rays of the light source are reflected on the inner (surface) of the inner pane, and ghost images can be avoided by spatially overlapping matte coatings, e.g., a ceramic black print, arranged behind it—for example, on the outer side or inner side of the outer pane or on the outer side of the inner pane. Alternatively, the reflection of the rays on a high-gloss, black film, which is arranged on the inner pane facing the interior, is described. To improve the external appearance of the laminated pane, this high-gloss, black film is then arranged completely within an overlap region with a cover print.

JP H 6 279071 A, which describes the arrangement of a hologram element in the overlap region with a ceramic, black masking print, also pursues the goal of improving the external appearance of the laminated pane. To protect the hologram element, it is arranged inside the laminated pane between the outer pane and the inner pane.

WO2020/0333593 A1 describes a windshield with an elaborately produced, nanostructured anti-reflective coating on the outer side of the outer pane with good durability against typical physical and chemical environmental influences. In addition to the coating on the outer pane, a nanostructured anti-reflective coating can also be applied to the inner surface of the inner pane, wherein an IR-reflective coating is then also designed as a reflective surface for visible light and is used to generate an HUD image, i.e., to allow or increase its visibility. In this described embodiment, the inner anti-reflective coating is applied to the IR reflective coating and can protect it from environmental influences. A water-repellent aluminum oxide coating can also be applied to the nanostructured anti-reflective coating.

The object of the present invention is to provide an improved laminated pane for a projection arrangement, in particular based upon head-up display technology, with which the described disadvantages can be avoided. The laminated pane should enable a good contrast of the generated image even with backlighting, and low energy consumption, as well as be able to be operated with a projection arrangement using p-polarized light. In addition, the element of the laminated pane intended for image generation, e.g., by reflection, should be protected in particular from external influences. Furthermore, a laminated pane according to the invention and a projection arrangement that can be realized with it should be easy and inexpensive to manufacture. A further object is the renewability of the protection and the possible retrofitting of vehicles with the projection arrangement according to the invention.

According to the invention, this object is achieved by a laminated pane according to claim 1 and a projection arrangement according to claim 12. Preferred embodiments result from the dependent claims.

According to the invention, a laminated pane is provided, in particular for a projection arrangement, which comprises at least an outer pane, a thermoplastic intermediate layer, and an inner pane, as well as a functional layer element, wherein the outer pane has an outer side I facing away from the thermoplastic intermediate layer and an inner side II facing the thermoplastic intermediate layer, and the inner pane has an outer side III facing the thermoplastic intermediate layer and an inner side IV facing away from the thermoplastic intermediate layer, wherein the functional layer element is a reflective layer, preferably a reflectively coated or a coating-free reflective polymer film or an active imaging element, and is arranged on the inner side IV of the inner pane and is suitable for emitting light, in particular p-polarized light, wherein the functional layer element itself is opaque or is arranged spatially in front of an opaque background when viewed through the laminated pane starting from the inner side IV of the inner pane, and a hydrophobic film is arranged at least on the functional layer element.

The functional layer element, e.g., preferably a reflective layer, is arranged in a planar manner according to the invention on the inner side IV of the inner pane, i.e., in other words, on the surface, facing the (vehicle) interior, of the inner pane. This has the advantage that, during the generation of an image, a secondary reflection, e.g., on the outer pane, is advantageously largely omitted, and the formation of ghost images can be avoided. Furthermore, with this arrangement, the position of the reflective layer can be selected more freely than with an arrangement between the outer pane and the inner pane, since the reflective layer cannot be covered by other opaque layers or elements, e.g., a masking strip.

According to the invention, the functional layer element is either opaque itself, i.e., substantially light-impermeable, or it is arranged in front of an opaque, substantially light-impermeable background starting from the inner side of the inner pane. In this context, the opaque background can be arranged on the outer side or inner side of the outer pane or within the thermoplastic intermediate layer. It has been shown that the functional layer element formed, for example, as a reflective layer overlapping the opaque background allows good imaging at high contrast to the opaque background, so that it appears bright and can thus also be seen perfectly.

Of course, the functional layer element itself can also be opaque and still be arranged spatially in front of the opaque background when viewed through the inner pane. For the purposes of the invention, at least the region of the laminated pane in or in front of which the functional layer element is arranged is opaque. If the functional layer element, e.g., a reflective layer, is arranged in front of the opaque background, it is preferably transparent.

The expression “in the view through the laminated pane” means looking through the laminated pane from the inner side of the inner pane. In the sense of the present invention, “spatially in front of” means, for the functional layer element, that it is arranged spatially further away from the outer side of the outer pane than at least the opaque background. According to the invention, the functional layer element is substantially always in complete overlap with the opaque background when viewed through the laminated pane, irrespective of whether it is applied directly to the opaque background or not. In other words, the functional layer element, e.g., a reflective layer, is thus located overlapping the opaque background when viewed through the laminated pane starting from the inner side of the inner pane. The combination of the reflective layer according to the invention with such an opaque background brings about good visibility of an image even in the case of external solar irradiation and when using faint light sources. Even under these circumstances, an image generated by a light source appears bright and can be seen perfectly. When using a laminated pane according to the invention in a projection arrangement, this allows a reduction in the power of the light source and thus reduced energy consumption.

According to the invention, it is further advantageously provided that a hydrophobic film be arranged at least on the functional layer element when viewed through the laminated pane starting from the inner side IV of the inner pane.

In other words, a hydrophobic film is arranged directly on the surface of the functional layer element at least on the surface, spatially opposite the inner side IV of the inner pane, of the functional layer element and seals off the surface coated therewith from the surrounding atmosphere. According to the invention, the hydrophobic film that is provided thus forms the outer surface, directed towards the interior, of the laminated pane, at least in the region of the functional layer element, and advantageously protects said pane, in particular the functional layer element, from external influences, in particular soiling. The hydrophobic film is a coating with good resistance to deposits of liquids, salts, grease, and dirt, for example, and is particularly easy to clean. For example, fingerprints from touching by a user can be avoided. Suitable hydrophobic films according to the invention, as well as their design and manufacture, are described, for example, in WO2005/084943, WO2007/012779, or WO2010/079299. Such hydrophobic coatings are already being used—for example, on the outer side of the outer pane of vehicles. Such hydrophobic films hold up well in this application, lasting two or more years. The hydrophobic coating allows water droplets to simply slide off the glazing, which can provide a driver with better visibility through a windshield in the rain. Advantageously, the use according to the invention of the hydrophobic coating on the inner side IV of the inner pane of the laminated pane means that the film is not directly exposed to the weather or to friction from windshield wipers and thus has a longer durability. The coating according to the invention is also, advantageously, easy to refresh. Suitable solutions for producing a hydrophobic film according to the invention are also available on the market and can be produced, for example, by simply applying such a solution in liquid form with a cloth.

Hydrophobic in the sense of the invention means that the film has a certain wetting characteristic, viz., that the contact angle of water in relation to the surface is greater than 90°. Preferably, the hydrophobic film is also oleophobic, i.e., the contact angle between surface and oil is greater than 50°. The hydrophobic film is, expediently, transparent and in no way impairs the view of the glazing that has the functional layer element, or the passage or perceptibility of the emitted, i.e., reflected, light.

In a preferred embodiment, it is provided that the hydrophobic film have a contact angle in relation to water of >100°, preferably >110°. Sealing with such a protective film ensures that the surface has particularly good dirt- and water-repellent properties and therefore needs to be cleaned less often. Hydrophobic coatings that are suitable according to the invention are available on the market in a wide variety of forms. In particular, these are fluoro-organic compounds, such as those described in DE19848591. Known hydrophobic coatings include products based upon perfluoropolyethers or fluorosilanes. These are, for example, layers applied in liquid form—for example, by spraying, dipping, and flooding, or by application using a cloth. A particular advantage of these coatings is the ease of replacing the hydrophobic film.

In one embodiment of the laminated pane according to the invention, it is provided that the hydrophobic film be applied to the functional layer element and additionally also to the inner side IV, which is not covered thereby, of the inner pane. In other words, the hydrophobic film forms the entire outer surface and a full-surface sealing relative to the interior—for example, a vehicle interior. This has the advantage that the associated water- and dirt-repellent properties of the hydrophobic film are also provided over the entire surface. Moreover, the production of such a full-surface seal relative to the interior can also be accomplished in a simple, efficient, and cost-effective manner.

According to the invention, the expression “emit light” means that light, in particular also p-polarized light, is reflected by the functional layer element, or, alternatively, the functional layer element itself is designed as an active light source (image display device) and emits light—for example, preferably p-polarized light. The functional layer element can therefore be designed as a reflective layer. Alternatively, the functional layer element can also be designed as a light source and be an active imaging element, such as an LCD or OLED display designed in the form of a layer, i.e., with a very low installation height (flat, thin). According to the invention, it is also possible for several identical or different first functional layer elements to be arranged directly adjacent to one another or spatially separated on the inner side of the inner pane (not overlapping),

The reflective layer preferably comprises at least one metal selected from a group comprising aluminum, tin, titanium, zirconium, hafnium, vanadium, niobium, tantalum, chromium, manganese, iron, cobalt, rhodium, iridium, nickel, palladium, platinum, copper, silver, gold, or mixture alloys thereof. The reflective layer can contain silicon oxide, independently or additionally.

In a particularly preferred embodiment of the invention, the reflective layer is a coating containing a thin-film stack, i.e., a layer sequence of thin, individual layers. This thin-film stack contains one or more electrically conductive layers on the basis of silver.

The electrically conductive layer on the basis of silver gives the reflective coating the basic reflective properties and also an IR-reflecting effect and electrical conductivity. The conductive layer preferably contains at least 90 wt. % silver, particularly preferably at least 99 wt. % silver, and very particularly preferably at least 99.9 wt. % silver. The silver layer can have dopants, e.g., palladium, gold, copper, or aluminum. Materials on the basis of silver are particularly suitable for reflecting p-polarized light. The use of silver in reflective layers has proven to be particularly advantageous in the reflection of p-polarized light. The coating has a thickness of 5 μm to 50 μm, and preferably of 8 μm to 25 μm.

If the reflective layer is designed as a coating, the layers are preferably directly applied to the inner side IV of the inner pane by physical vapor deposition (PVD), particularly preferably by cathode sputtering, and very particularly preferably by magnetic-field-assisted cathode sputtering (“magnetron sputtering”). In principle, however, the coating may also be applied, for example, by means of chemical vapor deposition (CVD), e.g., plasma-enhanced chemical vapor deposition (PECVD), by evaporation deposition, or by atomic layer deposition (ALD).

The reflective layer can also be designed as a reflective film which reflects light, preferably p-polarized light. The reflective layer can be a carrier film with a reflective coating or an uncoated, reflective polymer film. The reflective coating preferably comprises at least one layer on the basis of a metal and/or a dielectric layer sequence with alternating refractive indices. The layer on the basis of a metal preferably contains or consists of silver and/or aluminum. The dielectric layers can be formed, for example, on the basis of silicon nitride, zinc oxide, tin-zinc oxide, silicon-metal mixed nitrides such as silicon-zirconium nitride, zirconium oxide, niobium oxide, hafnium oxide, tantalum oxide, tungsten oxide, or silicon carbide. The oxides and nitrides mentioned can be deposited stoichiometrically, substoichiometrically, or hyperstoichiometrically. They can have dopings, e.g., aluminum, zirconium, titanium, or boron. The reflective polymer film preferably comprises or consists of dielectric polymer layers. The dielectric polymer layers preferably contain polyethylene terephthalate (PET). If the reflective layer is designed as a reflective film, it is preferably from 30 μm to 300 μm, particularly preferably from 50 μm to 200 μm, and in particular from 100 μm to 150 μm, thick.

If it is a coated, reflective film, the CVD or PVD coating methods can also be used to produce the film (carrier film)—for example, from polyethylene terephthalate (PET). Alternatively, the functional layer element can be designed as a thin glass layer element with a reflective coating, e.g., using a CVD or PVD method, which can be applied and arranged on the inner side IV of the inner pane using an adhesive film. Both a design using a reflective film or a separate reflective glass element also have the advantage that they can be easily refreshed if necessary. If the laminated pane is otherwise suitably designed, it can also be retrofitted—for example, for windshields in vehicles.

In one embodiment of the invention, the reflective layer is a reflective film which is metal-free and reflects visible light beams with a p-polarization. The polymer film therefore has intrinsic reflective properties. The reflective layer can be designed, for example, as a film which functions on the basis of synergistically interacting prisms and reflective polarizers. The polymer film can, for example, comprise a plurality of polymer layers having different refractive indices, wherein layers having higher and lower refractive indices are arranged alternately. In this case, the reflective effect is based in particular upon interference effects caused by the alternating high and low refractive polymer layers. Such films for the use of reflective coatings are commercially available.

The term “p-polarized light” means light from the visible spectral range that predominantly consists of light having p-polarization. The p-polarized light preferably has a light portion with p-polarization of ≥50%, preferably of ≥70%, and particularly preferably of ≥90%, and in particular of approximately 100%.

In one embodiment according to the invention, the opaque background is an opaque masking strip which is arranged regionally on at least one of the outer sides (I, III) and/or the inner sides (II, IV) of the inner and/or outer pane. The masking strip can in principle be arranged on each pane side of the outer pane. In the laminated pane according to the invention, it is preferably applied to the inner side of the outer pane, where it is protected from external influences. Alternatively or additionally, a marking strip is preferably provided on the inner side IV of the inner pane. In other words, the masking strip is then arranged between the inner side IV of the inner pane and the functional layer element.

The masking strip is preferably a coating of one or more layers. Alternatively, however, it may also be an opaque element, e.g., a film, embedded in the laminated pane.

According to a preferred embodiment of the laminated pane, the masking strip consists of a single layer. This has the advantage of a particularly simple and cost-effective manufacture of the laminated pane, since only a single layer has to be formed for the masking strip.

In addition to the mode of action described in the sense of the invention, it can serve as a masking of structures that can otherwise be seen through the pane in the installed state. In particular in the case of a windshield, the masking strip serves to mask an adhesive bead for adhesively bonding the windshield into a vehicle body. This means that it prevents the generally irregularly applied adhesive bead from being visible to the outside, so that a harmonious overall impression of the windshield is produced. On the other hand, the masking strip serves as UV protection for the adhesive material used. Permanent irradiation with UV light damages the adhesive material and would release the connection of the pane to the vehicle body over time. In the case of panes with an electrically controllable functional layer, the masking strip can, for example, also serve to cover busbars and/or connection elements.

The masking strip is printed, for example, onto the outer pane or inner pane, in particular by means of a screen printing method. The printing ink is thereby printed through a fine-mesh fabric onto the glass pane. The printing ink is pressed through the fabric with a rubber squeegee, for example. The fabric has regions that are permeable to the printing ink next to regions that are impermeable to the printing ink, thereby defining the geometric shape of the print. The fabric thus acts as a template for the print. The printing ink contains at least one pigment and glass frits, suspended in a liquid phase (solvent), e.g., water or organic solvents, such as alcohols. The pigment is typically a black pigment, such as pigment carbon black, aniline black, bone black, iron oxide black, spinel black, and/or graphite.

After printing the printing ink, the glass pane is subjected to a temperature treatment, wherein the liquid phase is expelled by evaporation, and the glass frits are melted and permanently connected to the glass surface. The temperature treatment is typically carried out at temperatures in the range of 450° C. to 700° C. As a masking strip, the pigment remains in the glass matrix formed by the molten glass frit. The masking strip preferably has a thickness of 5 μm to 50 μm, particularly preferably of 8 μm to 25 μm.

As already described, the masking strip can in principle be arranged on each side of the outer pane or the inner pane. In a laminated pane according to the invention, it is preferably applied to the inner side of the outer pane, where it is protected from external influences. Another preferred embodiment provides that, alternatively or additionally, a masking strip be arranged as a ceramic black print on the inner side IV of the inner pane, which can in particular improve the application of adhesive layers and the quality of bonding, in particular when installing the laminated pane according to the invention—for example, in a vehicle. In other words, the opaque background is preferably arranged as a ceramic black print on the inner side IV of the inner pane at least in an edge region, e.g., as a circumferential edge region, of the laminated pane. An outer pane edge region then remains free of further coatings, in particular free of reflective coating and hydrophobic film. This means that the regions intended for bonding, i.e., the regions adjacent to the edge of the pane, remain free of further coatings, such as reflective coating and hydrophobic film, and are available for secure and stable attachment by means of bonding.

Alternatively, the masking strip is a colored or pigmented, preferably black-pigmented, thermoplastic laminated film, which is preferably formed on the basis of polyvinyl butyral (PVB), ethyl vinyl acetate (EVA), or polyethylene terephthalate (PET), preferably PVB. The coloring or pigmentation of the laminated film can be freely selected, but is preferably black. The colored or pigmented laminated film is preferably arranged between the outer pane and the inner pane. The colored or pigmented thermoplastic laminated film preferably has a thickness of 0.25 mm to 1 mm. Preferably, the colored or pigmented laminated film extends over at most 50% and particularly preferably at most 30% of the surface of the laminated pane. In order to avoid differences in thickness in the laminated pane, a transparent further thermoplastic laminated film is preferably arranged between the outer pane and the inner pane and extends over at least 50%, preferably at least 70%, of the surface of the laminated pane. The colored or pigmented laminated film is arranged in the surface plane of the laminated pane at an offset from the transparent thermoplastic laminated pane so that they do not overlap or cover one another.

The masking strip may also be provided by a regionally pigmented or colored thermoplastic laminated film. In this case, the reflective layer is arranged spatially in front of the pigmented or colored region of the thermoplastic laminated film. The pigmentation or coloring of the laminated film preferably extends over a region of at most 50% and particularly preferably at most 30% of the surface of the laminated pane. The remaining part of the regionally pigmented or colored thermoplastic laminated film is transparent, i.e., without pigmentation or coloring. The regionally pigmented or colored thermoplastic laminated film preferably extends over the entire surface of the laminated pane. The embodiment of the masking strip as a pigmented or colored thermoplastic laminated film or as a regionally pigmented or colored thermoplastic laminated film simplifies the production of the laminated pane and improves its stability. It is very advantageous if the outer pane or the inner pane does not have to be coated beforehand in order to produce an opaque background. On the one hand, this increases the stability of the laminated pane, and furthermore improves process efficiency.

The outer pane and the inner pane preferably contain or consist of glass, particularly preferably flat glass, float glass, quartz glass, borosilicate glass, soda-lime glass, alumino silicate glass, or clear plastics, preferably rigid clear plastics, in particular polyethylene, polypropylene, polycarbonate, polymethyl methacrylate, polystyrene, polyamide, polyester, polyvinyl chloride, and/or mixtures thereof.

The outer pane and the inner pane can have further suitable coatings known per se, e.g., anti-reflective coatings, non-stick coatings, anti-scratch coatings, photocatalytic coatings, electrically conductive coatings or sun protection coatings, or low-e coatings.

The thickness of the individual panes (outer pane and inner pane) can vary widely and be adapted to the requirements of the individual case. Preferably, panes with the standard thicknesses of 0.5 mm to 5 mm and preferably of 1.0 mm to 2.5 mm are used. The size of the panes can vary widely and depends upon the use.

The laminated pane can have any three-dimensional shape. Preferably, the outer pane and the inner pane do not have any shadow zones, so that they can be coated, for example, by cathode sputtering. The outer pane and the inner pane are preferably flat or slightly or strongly curved in one direction or in several directions of the space.

According to the invention, the outer pane and the inner pane are preferably transparent. In the sense of the present invention, “transparent” means that the total transmission of the laminated pane complies with the legal provisions, e.g., for windshields (e.g., the European Union directives ECE-R43) and preferably has a transmissivity to visible light of more than 50% and in particular of more than 60%, e.g., more than 70%. The terms “transparent inner pane” and “transparent outer pane” thus mean that the inner pane and the outer pane are transparent in such a way that the view through a view-through region of the laminated pane fulfills the legal provisions for the desired use, e.g., for windshields. Accordingly, “opaque” means a light transmission of less than 10%, preferably less than 5%, and in particular 0%.

In the sense of the invention, “transparent outer pane” and “transparent inner pane” mean that seeing through the inner pane and the outer pane is possible. The light transmittance of the transparent outer pane and of the transparent inner pane is preferably at least 55%, particularly preferably at least 60%, and in particular at least 70%.

If a layer is formed “on the basis of” a material, the layer consists predominantly of this material, in particular substantially of this material, in addition to any impurities or doping.

The thermoplastic intermediate layer contains or consists of at least one thermoplastic polymer, preferably polyvinyl butyral (PVB), ethylene vinyl acetate (EVA), and/or polyurethane (PU), or copolymers or derivatives thereof, where applicable in combination with polyethylene terephthalate (PET). However, the thermoplastic intermediate layer may, for example, also contain polypropylene (PP), polyacrylate, polyethylene (PE), polycarbonate (PC), polymethyl methacrylate, polyvinyl chloride, polyacetate resin, casting resin, acrylate, fluorinated ethylene propylene, polyvinyl fluoride, and/or ethylene tetrafluoroethylene, or a copolymer or mixture thereof.

The thermoplastic intermediate layer is preferably designed as at least one thermoplastic laminated film and contains or consists of polyvinyl butyral (PVB), particularly preferably of polyvinyl butyral (PVB) and additives, such as plasticizers, known to the person skilled in the art. The thermoplastic intermediate layer preferably contains at least one plasticizer. Plasticizers are chemical compounds that make plastics softer, more flexible, smoother, and/or more elastic. They shift the thermoelastic range of plastics to lower temperatures so that the plastics have the desired, more elastic properties in the range of the operating temperature. Preferred plasticizers are, for example, carboxylic esters, in particular low-volatile carboxylic esters, fats, oils, soft resins, and camphor.

The thermoplastic intermediate layer on the basis of PVB preferably contains at least 3 wt. %, preferably at least 5 wt. %, particularly preferably at least 20 wt. %, even more preferably at least 30 wt. % and in particular at least 35 wt. % of a plasticizer. The plasticizer contains or consists, for example, of triethylene glycol bis (2-ethylhexanoate).

The thermoplastic intermediate layer may be formed by a single film or also by more than one film. The thermoplastic intermediate layer may be formed by one or more thermoplastic films arranged in a planar manner one above the other, wherein the thickness of the thermoplastic intermediate layer is preferably 0.25 mm to 1 mm—typically 0.38 mm or 0.76 mm.

The thermoplastic intermediate layer may also be a functional thermoplastic intermediate layer, in particular an intermediate layer with acoustically damping properties, an intermediate layer reflecting infrared radiation, an intermediate layer absorbing infrared radiation, and/or an intermediate layer absorbing UV radiation. Thus, the thermoplastic intermediate layer may, for example, also be a band filter film that blocks out narrow bands of visible light.

In a preferred embodiment of the invention, a second functional layer element is arranged between the inner side (II) of the outer pane and the outer side (III) of the inner pane, at least in a view-through region of the laminated pane. In other words, the second functional layer element also extends into at least one region of the laminated pane which has no overlap with an opaque background in the view through it and thus also has a functional region which has no overlap with the first functional layer element, and the two functional layer elements advantageously do not negatively influence one another in their function and can likewise be used in addition to one another. The second functional layer element may also optionally be introduced into the laminated pane over the entire surface or in a locally delimited manner. The second functional layer element may, for example, be a hologram, a p-pole coating, a reflective film, an HUD layer, or an active display.

An HUD layer is a reflective layer that is suitable for projecting an image emitted by a light source into the field of vision of an observer, such as a driver. The HUD layer preferably comprises at least one metal selected from the group comprising aluminum, tin, titanium, copper, chromium, cobalt, iron, manganese, zirconium, cerium, yttrium, silver, gold, platinum, and palladium, or mixtures thereof.

In a preferred embodiment of the invention, the HUD layer is a coating containing a thin-film stack, i.e., a layer sequence of thin individual layers. This thin-film stack contains one or more electrically conductive layers on the basis of silver. The electrically conductive layer on the basis of silver gives the reflective coating the basic reflective properties and also an IR-reflecting effect and electrical conductivity. The electrically conductive layer is formed on the basis of silver. The conductive layer preferably contains at least 90 wt. % silver, particularly preferably at least 99 wt. % silver, and very particularly preferably at least 99.9 wt. % silver. The silver layer can have dopants, e.g., palladium, gold, copper, or aluminum. Materials on the basis of silver are particularly suitable for reflecting p-polarized light. The use of silver has proven to be particularly advantageous in the reflection of p-polarized light. The coating has a thickness of 5 μm to 50 μm, and preferably of 8 μm to 25 μm.

If the HUD layer is designed as a coating, it is preferably applied to the inner pane or outer pane by physical vapor deposition (PVD), particularly preferably by cathode sputtering, and very particularly preferably by magnetic-field-assisted cathode sputtering (“magnetron sputtering”). In principle, however, the coating may also be applied, for example, by means of chemical vapor deposition (CVD), e.g., plasma-enhanced chemical vapor deposition (PECVD), by evaporation deposition, or by atomic layer deposition (ALD). The coating is applied to the panes before lamination.

The HUD layer may also be designed as a reflective film which reflects p-polarized light. The HUD layer may be a carrier film with a reflective coating, or a reflective polymer film. The reflective coating preferably comprises at least one layer on the basis of a metal and/or a dielectric layer sequence with alternating refractive indices. The layer on the basis of a metal preferably contains or consists of silver and/or aluminum. The dielectric layers can be formed, for example, on the basis of silicon nitride, zinc oxide, tin-zinc oxide, silicon-metal mixed nitrides, such as silicon-zirconium nitride, zirconium oxide, niobium oxide, hafnium oxide, tantalum oxide, or silicon carbide. The oxides and nitrides mentioned can be deposited stoichiometrically, substoichiometrically, or hyperstoichiometrically. They can have dopings, e.g., aluminum, zirconium, titanium, or boron. The reflective polymer film preferably comprises or consists of dielectric polymer layers. The dielectric polymer layers preferably contain PET. If the HUD layer is designed as a reflective film, it is preferably 30 μm to 300 μm, particularly preferably 50 μm to 200 μm, and in particular 100 μm to 150 μm, thick.

If the film is a coated, reflective film, the coating methods of CVD or PVD can likewise be used for the production.

According to a further preferred embodiment, the HUD layer is designed as a reflective film and is arranged within the thermoplastic intermediate layer. The advantage of this arrangement is that the HUD layer does not have to be applied to the outer pane or inner pane by means of thin film technology (e.g., CVD and PVD). This results in uses of the HUD layer with further advantageous functions, such as a more homogeneous reflection of the p-polarized light on the HUD layer. In addition, the production of the laminated pane can be simplified, since the HUD layer does not have to be arranged on the outer or inner pane via an additional method before lamination.

The invention further comprises a projection arrangement comprising a laminated pane according to the invention as described above in various embodiments, wherein the functional layer element is a reflective layer. The projection arrangement furthermore comprises a light source (image display device) which is assigned to the reflective layer, is directed onto the reflective layer, and irradiates the latter with light, in particular p-polarized light, wherein the reflective layer reflects the light. According to the invention, the reflective layer is protected from external influences, in particular from soiling, by a hydrophobic film applied thereto in a planar manner.

The light source of the projection arrangement emits light, preferably p-polarized light, and is arranged in the vicinity of the interior surface of the inner pane such that the light source irradiates this surface, wherein the light is reflected by the reflective layer of the laminated pane. If the projection arrangement according to the invention is operated with p-polarized light, a particular advantage is that it is also compatible with polarization-selective sunglasses.

According to the invention, the reflective layer preferably reflects more than 10%, preferably at least 30% or more, preferably 50% or more, and in particular 70% or more, of the light, in particular p-polarized light, impinging on the reflective layer, preferably in a wavelength range of 450 nm to 650 nm and at irradiation angles of 50 to 80°, e.g., of 55° to 75°. This is advantageous in order to achieve the highest possible brightness of an image emitted by the light source and reflected on the reflective layer.

The light source serves to emit an image and is also referred to according to the invention as an image display device. A projector, a display, or a different device known to the person skilled in the art can be used as the light source. The light source is preferably a display, particularly preferably an LCD display, LED display, OLED display, or electroluminescent display, in particular an LCD display. Displays have a low installation height and are thus simply integrated into the dashboard of a vehicle in a space-saving manner. Moreover, displays can be operated in a significantly more energy-saving manner in comparison to projectors. The comparatively lower brightness of displays is completely sufficient in combination with the reflective layer according to the invention and the opaque cover layer behind it. The radiation of the light source preferably impinges in the region of the reflective layer at an incidence angle of 55° to 80° on the laminated pane, preferably of 62° to 77° on the laminated pane. The incidence angle is the angle between the incidence vector of the radiation of the image display device and the surface normal in the geometric center of the reflective layer.

Furthermore, the invention comprises a method for producing a laminated pane and projection arrangement according to the invention.

The method for manufacturing a laminated pane according to the invention, as illustrated in various embodiments in the above description, may comprise at least the following steps:
(a) providing an outer pane, an inner pane, and a thermoplastic intermediate layer,
(b) inserting or applying at least one opaque background, in particular as an opaque layer, preferably as a masking strip, in at least a second sub-region of the interior surface of the outer pane (II), the outer surface of the outer pane (I), and/or on the outer surface of the inner pane (III), and/or as an intermediate layer which is tinted or colored at least in certain regions,
(c) assembling the inner pane, the thermoplastic intermediate layer, and the outer pane in this order to form a layer stack,
(d) laminating the layer stack to form a laminated pane,
(e) applying a reflective layer and/or an active imaging element to at least a first sub-region of the interior surface (IV) of the inner pane (3), wherein the first sub-region extends at least partially overlapping with the second sub-region, and wherein the applied reflective layer (9) or the active imaging element is arranged on the interior surface (IV) of the inner pane,
(f) applying a hydrophobic film as an exposed layer, at least on the reflective layer (9) and/or the active imaging element.

The method for manufacturing a projection arrangement may comprise at least the following steps:
(a) providing an outer pane, an inner pane, and a thermoplastic intermediate layer,
(b) applying at least one opaque cover layer, in particular as a masking strip, in at least one second sub-region of the interior surface of the outer pane, the outer surface of the inner pane, and/or on the outer surface of the inner pane,
(c) assembling the inner pane, the thermoplastic intermediate layer, and the outer pane in this order to form a layer stack,
(d) laminating the layer stack to form a laminated pane,
(e) attaching a reflective layer on at least a first sub-region of the interior surface of the inner pane, wherein the first sub-region extends at least partially overlapping with the second sub-region, and wherein the applied reflective layer is located as an exposed layer on the interior surface of the inner pane,
(f) applying a hydrophobic film at least on the reflective layer,
(g) providing and directing a light source (image display device), preferably for p-polarized light, onto the laminated pane so that the light can impinge on the reflective layer.

Step e) of the method optionally takes place, in each case, before, during, or after steps a) through d). However, if at least one opaque masking strip is applied on the interior surface IV of the inner pane, the reflective layer is applied only after the application of said opaque cover layer. The hydrophobic film according to the invention is applied after the reflective layer or the active imaging element has been applied at least to its surface—for example, by applying liquid, e.g., by spraying, dipping, flooding, or also by application with a cloth. The hydrophobic film can also be applied over the entire surface of the inner side of the inner pane, i.e., it can also extend to the regions of the inner surface of the inner pane that are not covered by the first functional layer element. A particular advantage of the invention results from the fact that the hydrophobic layer, and possibly also the first functional layer element, can be designed to be refreshed and is easily replaceable, or that there are also options for retrofitting—for example, for vehicle windows.

The production of the laminated pane or projection arrangement according to the invention is simple, cost-effective, and, due to the described possible ability to refresh or retrofit, also particularly sustainable, and can also be easily integrated into existing industrial series production.

Lamination of the layer stack takes place under the action of heat, vacuum, and/or pressure, wherein the individual layers are bonded (laminated) by at least one thermoplastic intermediate layer. Methods known per se for producing a laminated pane can be used. For example, so-called autoclave processes can be carried out at an elevated pressure of about 10 bar to 15 bar and temperatures of 130° C. to 145° C. over about 2 hours. Vacuum bag or vacuum ring methods known per se operate, for example, at approximately 200 mbar and 130° C. to 145° C. The outer pane, the inner pane, and the thermoplastic intermediate layer may also be pressed in a calender between at least one roller pair to form a laminated pane. Systems of this type for the production of laminated panes are known and usually have at least one heating tunnel upstream of a pressing unit. The temperature during pressing is, for example, from 40° C. to 150° C. Combinations of calender and autoclave methods have proven particularly successful in practice. Vacuum laminators can be used as an alternative. They consist of one or more heatable and evacuable chambers in which the outer pane and the inner pane can be laminated within, for example, approximately 60 minutes at reduced pressures of 0.01 mbar to 800 mbar and temperatures of 80° C. to 170° C.

The invention furthermore extends to the use of the laminated pane or projection arrangement according to the invention in means of transportation on land, in the air, or on water-in particular, in motor vehicles—wherein the laminated pane can be used, for example, as a windshield, rear pane, side pane, and/or glass roof, and preferably as a windshield. The use of the laminated pane as a vehicle windshield is preferred. Alternatively, the glazing can be an architectural glass, for example, in an outer façade of a building or a separating pane in the interior of a building, or a built-in part in furniture or devices.

The various embodiments of the invention may be implemented individually or in any combinations. In particular, the features mentioned above and to be explained below can be used not only in the specified combinations but also in other combinations or alone, unless they are expressly possible and described only as alternatives to one another, without departing from the scope of the present invention.

The invention is explained in more detail below with reference to exemplary embodiments, wherein reference is made to the accompanying figures. In a simplified, not-to-scale representation:

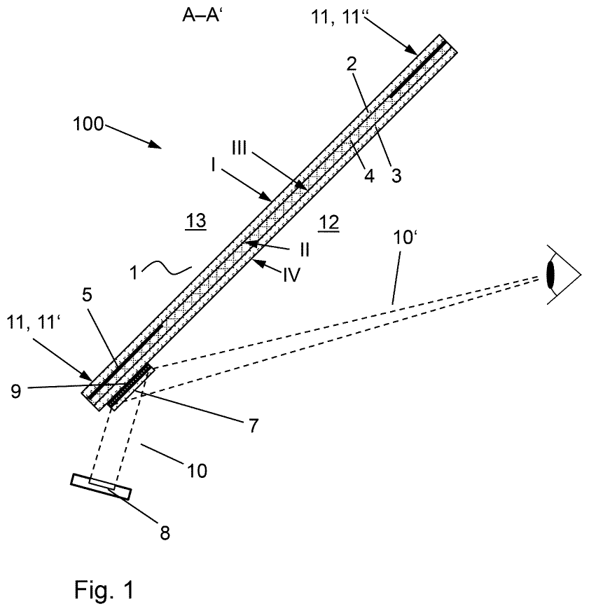

FIG. 1 shows a cross-sectional view of an exemplary embodiment of the projection arrangement according to the invention,

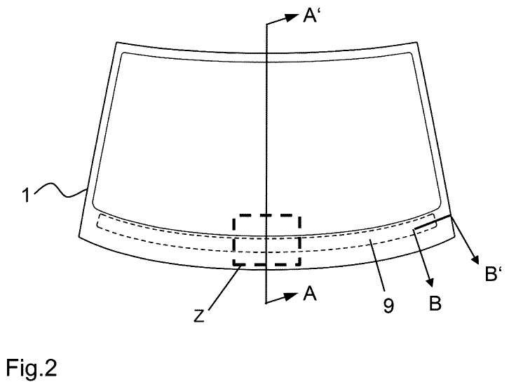

FIG. 2 shows a plan view of a laminated pane of FIG. 1,

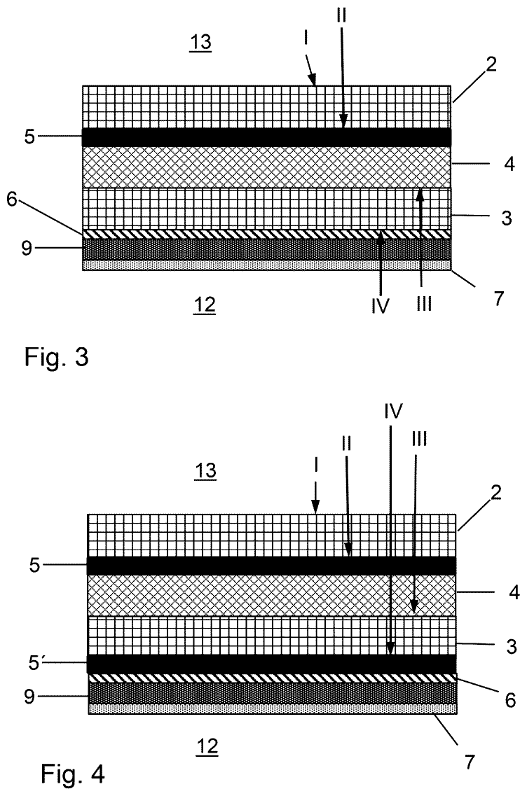

FIG. 3-6 show enlarged cross-sectional views of different embodiments of the layer sequences according to the invention of the laminated pane 1 in the region of the functional layer element, and

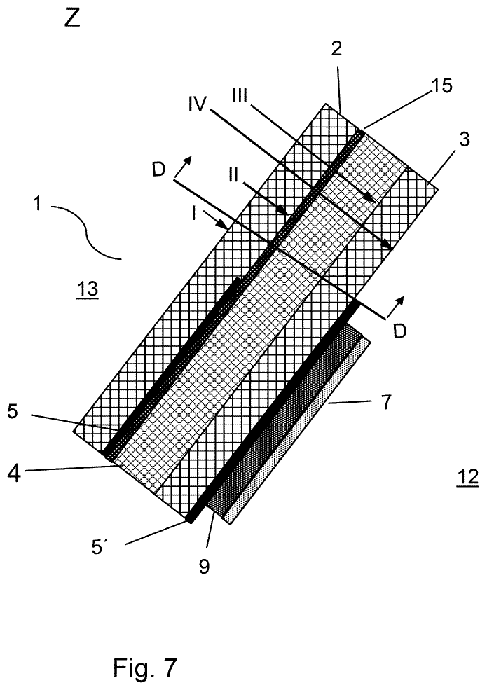

FIG. 7 shows an enlarged cross-sectional view of an embodiment of the layer sequence according to the invention of the laminated pane 1 in the region Z.

FIG. 1 shows a cross-sectional view of an exemplary embodiment of the projection arrangement 100 according to the invention in a vehicle in a highly simplified, schematic representation. A plan view of the laminated pane 1 of the projection arrangement 100 is shown in FIG. 2. The cross-sectional view of FIG. 1 corresponds to the section line A-A of the laminated pane 1, as indicated in FIG. 2.

The laminated pane 1 is designed in the form of a laminated pane (see also FIGS. 3 to 4) and comprises an outer pane 2 and an inner pane 3 with a thermoplastic intermediate layer 4, which is arranged between the panes 2, 3. The laminated pane 1 is, for example, installed in a vehicle and separates a vehicle interior 12 from an external environment 13. The laminated pane 1 is, for example, the windshield of a motor vehicle.

The outer pane 2 and the inner pane 3 each consist of glass—preferably thermally pre-stressed soda-lime glass—and are transparent to visible light. The thermoplastic intermediate layer 4 consists of a thermoplastic plastic, preferably polyvinyl butyral

(PVB), ethylene vinyl acetate (EVA), and/or polyethylene terephthalate (PET).

The outer side I of the outer pane 2 faces away from the thermoplastic intermediate layer 4 and is, at the same time, the outer surface of the laminated pane 1. The inner side Il of the outer pane 2 and the outer side III of the inner pane 3 each face the intermediate layer 4. The inner side IV of the inner pane 3 faces away from the thermoplastic intermediate layer 4 and is, at the same time, the inner side of the laminated pane 1. It is understood that the laminated pane 1 can have any suitable geometric shape and/or curvature. As a laminated pane 1, e.g., for a vehicle, it typically has a convex curvature.

A frame-like, peripheral first masking strip 5 is located on the inner side II of the outer pane 2 in an edge region 11 of the laminated pane 1. The first masking strip 5 is opaque and obstructs the view, from outside, of structures arranged on the inside of the laminated pane 1, e.g., an adhesive bead for adhesively bonding the laminated pane 1 into a vehicle body. The first masking strip 5 is preferably black. The first masking strip 5 consists, for example, of an electrically non-conductive material traditionally used for masking strips, e.g., a black-colored screen printing ink which is burnt in.

Furthermore, the laminated pane 1 can have a second masking strip 5′ in the edge region 11 on the inner side IV of the inner pane 3 (not shown here; see FIGS. 6 and 7). The second masking strip 5′ is preferably formed in a frame-like, circumferential manner. Like the first masking strip 5, the second masking strip 5′ comprises an electrically non-conductive material traditionally used for masking strips—for example, a black-colored screen printing ink which is burnt in.

A reflective layer 9 as a functional layer element is located spatially in front of the first masking strip 5 on the inner side IV of the inner pane 3 and is vapor-deposited, for example, by means of the PVD method. The reflective layer 9 is, for example, a metal coating which contains at least one thin-film stack with at least a silver layer and a dielectric layer. In this embodiment shown, the reflective layer 9 is in direct contact with the interior surface IV of the inner pane 3. Alternatively, the reflective layer 9 can also be designed as a reflective film and optionally attached using an adhesive film (not shown here; see FIG. 3). The reflective film can have a reflective metal coating. In the view through the laminated pane 1, the reflective layer 9 is arranged spatially in front of an opaque background—here, the masking strip 5—wherein the masking strip 5 completely covers the reflective layer 9, i.e., the reflective layer 9 has no portion that does not overlap the masking strip 5. The reflective layer 9 is arranged here, for example, only in the lower (motor-side) portion 11′ of the edge region 11 of the laminated pane 1. However, it would also be possible to arrange the reflective layer 9 in the upper (roof-side) portion 11″ or in a lateral portion of the edge region 11. Furthermore, several reflective layers 9 could be provided, which are arranged, for example, in the lower (motor-side) portion 11′ and in the upper (roof-side) portion 11″ of the edge region 11. For example, the reflective layers 9 could also be arranged such that a (partially) peripheral image can be generated. However, it is also possible according to the invention to provide both an opaque background (masking) and a reflective layer 9 in every suitable region of the laminated pane (not shown here). An edge-side arrangement is of course advantageous and expedient in a use and embodiment of the laminated pane 1 as a windshield in order to fulfill the stipulated requirements for the field of view of the driver.

According to the invention, a hydrophobic film 7 is arranged on the surface, facing the vehicle interior 12, of the reflective layer 9. According to the invention, the hydrophobic film 7 thus forms, at least in the region of the reflective layer, the outer surface, which is directed towards the interior 12 and exposed to the surrounding atmosphere, of the laminated pane 1. The surface covered with the hydrophobic film 7, in particular the functional layer element 9, is thus advantageously protected against external influences, in particular against deposits of liquids, salts, grease, and dirt, for example, and is particularly easy to clean. The hydrophobic film 7 according to the invention is, advantageously, resistant. In addition, the hydrophobic film 7 can also be easily refreshed if necessary—for example, by applying it in liquid form with a cloth. In one embodiment not shown here, the further surface IV, which is not coated by the reflective layer 9 and faces the interior 12, of the laminated pane 1 is also provided with the hydrophobic film 7 and thus sealed towards the interior 12. This has the advantage that the water- and dirt-repellent properties of the hydrophobic film associated therewith can likewise be provided over the entire surface. Moreover, the production of such a full-surface seal towards the interior 12 can also be accomplished in a simple, efficient, and cost-effective manner.

The first masking strip 5 may also be widened in the lower (motor-side) portion 11′ of the edge region 11, i.e., the first masking strip 5 has a greater width in the lower (motor-side) portion 11′ of the edge region 11 than in the upper (roof-side) portion 11″ of the edge region 11 (as in the lateral portions of the edge region 11, which cannot be seen in FIG. 1) of the laminated pane 1. “Width” is understood to mean the dimension of the first masking strip 5 perpendicular to its extension. The projection arrangement 100 furthermore has an image display device 8, which is, for example, arranged in the dashboard (not shown), as an image generator. The image display device 8 is used to generate light, in particular p-polarized light 10 (image information), which is directed onto the reflective layer 9 and is reflected by the reflective layer 9 as reflected light 10′ into the vehicle interior 12, where it can be seen by a viewer, e.g., a driver. The reflective layer 9 is suitably designed to reflect the light, preferably the p-polarized light 10 of the image display device 8, i.e., an image of the image display device 8. The light 10 of the image display device 8 preferably impinges on the laminated pane 1 at an incidence angle of 50° to 80°, in particular of 55° to 75°, e.g., of 60° to 70°, typically approximately 65°, as is customary for HUD projection arrangements. It would also be possible, for example, to arrange the image display device 8 in the A-pillar of a motor vehicle or on the roof (in each case on the vehicle interior side) if the reflective layer 9 is suitably positioned for this purpose. If several reflective layers 9 are provided, a separate image display device 8 can be assigned to each reflective layer 9, i.e., several image display devices 8 can be arranged. The image display device 8 is, for example, a display such as an LCD display, OLED display, EL display, or uLED display. It would also be possible, for example, for the laminated pane 1 to be a roof pane, side pane, or rear pane of a vehicle.

In the plan view of FIG. 2, the reflective layer 9 is shown in extension along the lower portion of the edge region 11′ of the laminated pane 1.

Reference is now made to FIGS. 3 to 7, in which enlarged cross-sectional views of various embodiments of the laminated pane 1 are shown. The cross-sectional views in FIGS. 3 to 5 correspond to the section line A-A (FIG. 2) in the region of the reflective layer 9. The cross-sectional view of FIG. 6 corresponds to the section line B-B′ (FIG. 2). The view shown in FIG. 7 of the section line A-A in the lower section Z of the edge region 11′ of the laminated pane 1, as indicated in FIG. 2.

FIG. 3 shows an embodiment in which a masking strip 5 is applied to the inner side Il of the outer pane 2, e.g., as a black print, and is located spatially in front of the reflective layer 9 (first functional layer element) as an opaque background. The outer pane 2 is connected to the inner pane 3 via the thermoplastic intermediate layer 4, which is preferably a PVB film. In this embodiment, the reflective layer 9 is bonded to the inner side IV of the inner pane 3 via an adhesive layer 6. Alternatively, the reflective layer can also be designed without the adhesive layer in direct contact with the inner side IV of the inner pane. For example, the reflective layer can be produced as a coating by CVD or PVD methods on the inner side IV of the inner pane 3. According to the invention, a hydrophobic film 7 is arranged on the surface, facing the vehicle interior 12, of the reflective layer 9. According to the invention, the hydrophobic film 7 thus forms the outer, exposed surface, directed towards the interior 12, of the laminated pane 1, at least in the region of the reflective layer 9, and thus advantageously protects against external influences, in particular against deposits—for example, of liquids, salts, grease, and dirt.

FIG. 4 shows a further embodiment of the cross-section of the laminated pane 1 according to the invention, which differs from the structure in FIG. 3 in that, on the inner side IV of the inner pane, a masking strip 5′ is additionally provided, on which the reflective layer 9 is arranged via an optional adhesive layer 6. As shown here, this masking strip 5′ can also be provided in another configuration as an alternative to the first masking strip 5. Like the first masking strip 5, the second masking strip 5′ may comprise, for example, an electrically non-conductive material traditionally used for masking strips—for example, a black-colored screen printing ink which is burnt in.

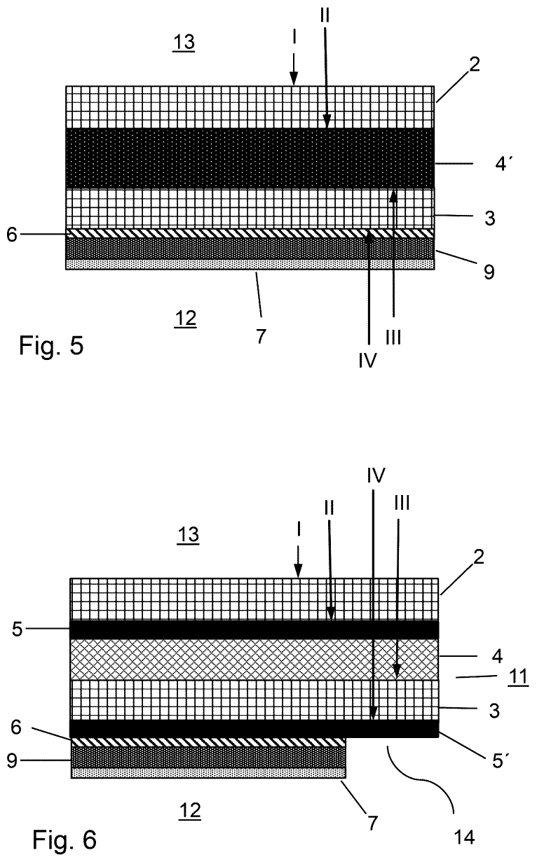

FIG. 5 shows another embodiment of the laminated pane 1 according to the invention in cross-section, wherein, in contrast to the embodiments in FIG. 3 or 4, the opaque background (masking strip) is not formed by a black print 5 on the inner side II of the outer pane 2, but is realized by a colored thermoplastic film—for example, a colored PVB film as a laminated film 4′. One or more black prints 5 or 5′ can, as further additional layers, advantageously be used as mask adhesions (not shown here).

FIG. 6 shows a preferred embodiment in which it is provided that the masking strip 5′, as a ceramic black print on the inner side IV of the inner pane 3, preferably be arranged circumferentially in the edge region 11, 11′, 11″ of the laminated pane 1, wherein an outer pane edge region 14 remains free of further coatings, in particular free of reflective layer 9 and hydrophobic film 7. In addition to its function as an opaque background for the reflective layer 9, this masking strip 5′ can also improve the application of adhesive layers and the quality of bonding, particularly when installing the laminated pane 1 according to the invention—for example, in a vehicle. Preferably, as shown schematically, an outer pane edge region 14 of, for example, 3-5 cm, i.e., the regions of the laminated pane 1 provided for bonding to a body, remains free of further coatings, such as reflective layer 9 and hydrophobic film 7, and is available for secure and stable attachment by bonding.

FIG. 7 schematically shows a combination according to the invention with a second functional layer element, e.g., an HUD layer 15. In this embodiment, the reflective layer 9, provided on the interior surface of the inner pane, as well as the masking strip 5 attached as an opaque background in this region are preferably only locally limited to the lower edge region 11 of the laminated pane 1 and thus do not influence an HUD layer 15 attached in the view-through region D of the laminated pane 1. Because the reflective layer is positioned on the interior surface IV of the laminated pane 1, the HUD layer 15 can be attached independently of the latter to one of the internal surfaces of the laminated pane 1 and is protected there from environmental influences.

### LIST OF REFERENCE SIGNS

1 Laminated pane
2 Outer pane
3 Inner pane
4 Thermoplastic intermediate layer
4′ Colored thermoplastic laminated film
5,5′ Masking strip
6 Adhesive layer
7 Hydrophobic film
8 Image display device
9 Reflective layer (first functional layer element)
10, 10′ Light (preferably p-polarized light)
11, 11′, 11″ Edge region
12 (Vehicle) interior
13 External environment
14 Outer edge region (bonding/fastening region)
15 HUD layer (second functional layer element)
100 Projection assembly
I Outer side of the outer pane 2
II Inner side of the outer pane 2
III Outer side of the inner pane 3
IV Inner side of the inner pane 3
D View-through region
A-A′ Cutting line
B-B′ Cutting line
Z Enlarged region

1. A laminated pane, comprising at least an outer pane, a thermoplastic intermediate layer, and an inner pane, a functional layer element,
wherein the outer pane has an outer side facing away from the thermoplastic intermediate layer and an inner side facing the thermoplastic intermediate layer, and the inner pane has an outer side facing the thermoplastic intermediate layer and an inner side facing away from the thermoplastic intermediate layer,
wherein the functional layer element is a reflective layer, or an active imaging element, and is arranged on the inner side of the inner pane and is suitable for emitting light,
wherein the functional layer element itself is opaque or is arranged spatially in front of an opaque background when viewed through the laminated pane starting from the inner side of the inner pane, and wherein a hydrophobic film is arranged at least on the functional layer element.

2. The laminated pane according to claim 1, wherein the hydrophobic film has a contact angle in relation to water of >100°, and/or the hydrophobic film is additionally oleophobic, and the contact angle between surface and oil is greater than 50°.

3. The laminated pane according to claim 1, wherein the hydrophobic film is applied to the functional layer element and additionally to the region, not covered by the functional layer element, on the inner side of the inner pane.

4. The laminated pane according to claim 1, wherein the opaque background is a masking strip, which is arranged in regions at least on one of the outer sides and/or the inner sides of the inner and/or outer pane.

5. The laminated pane according to claim 1, wherein the opaque background, as a masking strip, is formed as an opaque thermoplastic film and is arranged on the inner side of the outer pane and/or on the outer side of the inner pane, or the masking strip is formed by a uniform, regionally colored or tinted laminated film.

6. The laminated pane according to claim 1, wherein the opaque background is arranged at least in an edge region of the outer pane and/or of the inner pane.

7. The laminated pane according to claim 1, comprising a masking strip is arranged on the inner side of the outer pane and/or between the inner side of the inner pane and the functional layer element.

8. The laminated pane according to claim 1, comprising a masking strip is arranged on the inner side of the inner pane at least in an edge region, of the laminated pane, and an outer pane edge region remains free of further coatings.

9. The laminated pane according to claim 1, wherein the reflective layer contains at least one metal.

10. The laminated pane according to claim 1, wherein, in a view-through region of the laminated pane, a second functional layer element, is arranged between the inner side of the outer pane and the outer side of the inner pane.

11. Projection A projection arrangement comprising:
a laminated pane according to claim 1, wherein the functional layer element is a reflection layer;
an image display device, which is assigned to the reflective layer, is directed onto the reflective layer, and irradiates said reflective layer with light, wherein the reflective layer reflects the light.

12. The projection arrangement according to claim 11 in which the reflective layer reflects 30% or more impinging on the reflective layer.

13. The projection arrangement according to claim 11, wherein the image display device is a display.

14. A method for producing a laminated pane according to claim 1, comprising:
(a) providing an outer pane, an inner pane, and a thermoplastic intermediate layer,
(b) inserting or applying at least one opaque background, in at least a second sub-region of the interior surface of the outer pane, the outer surface of the outer pane, and/or on the outer surface of the inner pane, and/or as an intermediate layer which is tinted or colored at least in some regions,
(c) assembling the inner pane, the thermoplastic intermediate layer, and the outer pane in this sequence to form a layer stack,
(d) laminating the layer stack to form a laminated pane,
(e) applying a reflective layer and/or an active imaging element to at least a first sub-region of the interior surface of the inner pane, wherein the first sub-region extends at least partially overlapping with the second sub-region, and wherein the applied reflective layer or the active imaging element is arranged on the interior surface of the inner pane,
(f) applying a hydrophobic film as an exposed layer, at least on the reflective layer and/or the active imaging element.

15. A method comprising providing a laminated pane according to claim 1, in a vehicle for transport on land, in the air, or on water.

16. The laminated pane according to claim 1, wherein the laminated pane is a laminated pane of a projection arrangement.

17. The laminated pane according to claim 1, wherein the reflective layer is a reflectively coated or a coating-free reflective polymer film.

18. The laminated pane according to claim 1, wherein the light is p-polarized light.

19. The laminated pane according to claim 2, wherein the hydrophobic film has a contact angle in relation to water of >110°.

20. The laminated pane according to claim 8, wherein the masking strip is arranged as a ceramic black print.
